(19) United States
(12) Patent Application Publication
(10) Pub. No.: US 2005/0219643 A1
(43) Pub. Date: Oct. 6, 2005

(54) Optical scanning device

(76) Inventors: Bernadus Hendrikus Wilhelms Hendriks, Eindhoven (NL); Jorrit Ernst De Vries, Eindhoven (NL)

Correspondence Address: Philips Electronics North America Corporation;Corporate Patent Counsel, PO Box 3001, Briarcliff Manor, NY, 10510, US

(21) Appl. No.: 10/501,441

(22) PCT Filed: Jan. 16, 2003
(86) PCT No.: PCT/IB03/00093

§ 371 Date: Jul. 13, 2004

(30) Foreign Application Priority Data
Jan. 17, 2002 (EP) 02075209.3
Jul. 22, 2002 (EP) 02077992.2

(51) Int. Cl. G11B 7/00; H04N 1/04

(52) U.S. Cl. 358/474

(57) ABSTRACT

An optical device (1) for scanning three information layers (2, 2′, 2″) by means of three radiation beams (4, 4′, 4″) having three respective wavelengths (λ₁, λ₂, λ₃) and polarizations (p₁, p₂, p₃), wherein the three wavelengths substantially differ from each other. The device comprises a radiation source (7) for emitting the three radiation beams, an objective lens system (8) for converging the three radiation beams beam on the positions of the three respective information layers, and a phase structure (24) having a non-periodic stepped profile. Furthermore, the structure includes birefringent material sensitive to the three polarizations and the stepped profile is designed for introducing three wavefront modifications (ΔW₁, ΔW₂, ΔW₃) for the three wavelengths, respectively, wherein one of the wavefront modifications is of a type different from the others and one of the polarizations differs from the others.

The present invention relates to an optical scanning device for scanning a first information layer by means of a first radiation beam having a first wavelength and a first polarization, a second information layer by means of a second radiation beam having a second wavelength and a second polarization, and a third information layer by means of a third radiation beam having a third wavelength and a third polarization, wherein said first, second and third wavelengths substantially differ from each other, the device comprising:

a radiation source for emitting said first, second and third radiation beams consecutively or simultaneously,

an objective lens system for converging said first, second and third radiation beams beam on the positions of said first, second and third information layers, and

a phase structure with a non-periodic stepped profile, arranged in the optical path of said first, second and third radiation beams, the structure including a plurality of steps with different heights for forming said non-periodic stepped profile.

One particular illustrative embodiment of the invention relates to an optical scanning device that is capable of reading data from three different types of optical record carriers, such as compact discs (CDs), conventional digital versatile discs (DVDs) and so-called next generation HD-DVDs.

The present invention also relates to a phase structure for use in an optical scanning device for scanning a first information layer by means of a first radiation beam having a first wavelength and a first polarization, a second information layer by means of a second radiation beam having a second wavelength and a second polarization, and a third information layer by means of a third radiation beam having a third wavelength and a third polarization, wherein said first, second and third wavelengths substantially differ from each other, the structure being arranged in the optical path of said first, second and third radiation beams and having a non-periodic stepped profile.

“Scanning an information layer” refers to scanning by means of a radiation beam for reading information in the information layer (“reading mode”), writing information in the information layer (“writing mode”), and/or erasing information in the information layer (“erase mode”). “Information density” refers to the amount of stored information per unit area of the information layer. It is determined by, inter alia, the size of the scanning spot formed by the scanning device on the information layer to be scanned. The information density may be increased by decreasing the size of the scanning spot. Since the size of the spot depends, inter alia, on the wavelength λ and the numerical aperture NA of the radiation beam forming the spot, the size of the scanning spot can be decreased by increasing NA and/or by decreasing λ.

In the following a first optical element with an optical axis, e.g. an objective lens, for transforming an object to an image may deteriorate the image by introducing a “wavefront aberration” W_{abb}. Wavefront abberations have different types expressed in the form of the so-called Zernike polynomials with different orders. Wavefront tilt or distortion is an example of a wavefront aberration of the first order. Astigmatism and curvature of field and defocus are two examples of a wavefront aberration of the second order. Coma is an example of a wavefront aberration of the third order. Spherical aberration is an example of a wavefront aberration of the fourth order. It is noted that some wavefront aberrations, such as wavefront tilt, astigmatism and coma, are asymmetric with respect to the optical axis, i.e. dependent on a direction in a plane perpendicular to that axis. Some wavefront modifications, such as defocus and spherical aberration, are symmetric with respect to the optical axis, i.e. independent on any direction in a plane perpendicular to that axis. For more information on the mathematical functions representing the aforementioned wavefront aberrations, see, e.g. the book by M. Born and E. Wolf entitled “Principles of Optics,” pp. 464-470 (Pergamon Press 6^{th} Ed.) (ISBN 0-08-026482-4).

A radiation beam propagating along an optical path has a wavefront W with a predetermined shape, given by the following equation:

$$\frac{W}{λ} = \frac{Φ}{2 π} \qquad ( 0 a )$$

where “λ” and “Φ” are the wavelength and the phase of the radiation beam, respectively.

In the following a second optical element with an optical axis, e.g. a non-periodic phase structure, may be arranged in the optical path of the radiation beam for introducing a “wavefront modification” ΔW in the radiation beam. The wavefront modification ΔW is a modification of the shape of the wavefront W. It may be of a first, second, etc. order of a radius in the cross-section of the radiation beam if the mathematical function describing the wavefront modification ΔW has a radial order of three, four, etc., respectively. The wavefront modification ΔW may also be “flat”; this means that the second optical element introduces in the radiation beam introduces a constant phase change so that, after taking modulo 2π of the wavefront modification ΔW, the resulting wavefront is constant. The term “flat” does not necessarily imply that the wavefront W exhibits a zero phase change. Furthermore, it derived from Equation (0a) that the wavefront modification ΔW may be expressed in the form of a phase change ΔΦ of the radiation beam, given by the following equation:

$$Δ Φ = \frac{2 π}{λ} Δ W \qquad ( 0 b )$$

In the following the so-called optical path difference OPD may be calculated for either a wavefront aberration W_{abb} or a wavefront modification ΔW. In the case where the wavefront modification or aberration is symmetric with respect to the optical axis, the root-mean-square value OPDᵣₘₛ of the optical path difference OPD is given by the following equation:

$${OPD}_{rm s} = \sqrt{\frac{\int {f ( r )}^{2} r ⅆ r}{\int r ⅆ r} - {( \frac{\int f ( r ) r ⅆ r}{\int r ⅆ r} )}^{2}} \qquad ( 0 c )$$

where “f” is the mathematical function which describes the wavefront aberration W_{abb} or the wavefront modification ΔW and “r” is the polar coordinate of the polar coordinate system (r, θ) in a plane normal to the optical axis, with the origin of the system is the point of intersection of that plane and the optical axis and extending over the entrance pupil of the corresponding optical element. It is noted that Equation (0c) is applicable to spherical aberration and defocus which are symmetric wavefront aberrations.

In the present description two values OPD_{rms,1} and OPD_{rms,2} are “substantially equal” to each other where |OPD_{rms,1}−OPD_{rms,2}| is less than or equal to, preferably, 30mλ, where the value 30mλ has been chosen arbitrarily. Also, two values of phase changes Δφₐ and Δφ_{b} are “substantially equal” to each other where the respective values OPD_{rms,1} and OPD_{rms,2} are “substantially equal” to each other (the relationship between Δφ and ΔW being given in Equation (0b)). Similarly, two values OPD_{rms,1} and OPD_{rms,2} (or two values of phase changes Δφₐ and Δφ_{b}) are “substantially different” from each other where |OPD_{rms,1}−OPD_{rms,2}| is more than or equal to, preferably, 30 mλ, where the value 30 mλ has been chosen arbitrarily.

In the following the term “approximate” or “approximation” is used herein, that it is intended to cover a range of possible approximations, the definition including approximations which are in any case sufficient to provide a working embodiment of an optical scanning device serving the purpose of scanning different types of optical record carriers.

There is currently a need in the field of optical storage for providing optical scanning devices having one optical objective lens for scanning a variety of different optical carriers using different wavelengths of laser radiation, such as a first disc of the so-called BD-format (Blu-ray Disc), a second disc of the so-called DVD-format and a third disc of the so-called CD-format.

For instance, a typical problem is to make an optical scanning device compatible with all currently existing disks, i.e. DVD-format discs and CD-format disc and “H-DVD”-format discs readout, by means of a first radiation beam with a first wavelength that equals 785 nm (to read CD-R), a second radiation beam with a second wavelength that equals 405 nm, and a third radiation beam with a third wavelength that equals 650 nm (to read dual-layer DVD). Due to this plurality of wavelengths, designing a non-periodic phase structure generating predefined wavefronts for each wavelength configuration is difficult. The reason for this is that in designing a non-periodic phase structure (NPS) one makes use of the fact that the phase introduced by a step height h is different when the wavelength is different. For two wavelength such a structure allows for rather simple designs. It is noted that a method for designing an NPS is known from, e.g., the article by B. H. W. Hendriks, J. E. de Vries and H. P. Urbach, “Application of non-periodic phase structures in optical systems”, Appl. Opt 40 (2001) pp. 6548-6560, which describes how to make a objective lens suitable for scanning DVD-format discs and CD-format discs with the aid of an NPS.

It has previously been proposed in, for example, the European Patent application filed on May 4, 2001 with the application number EP 01201255.5, to provide optical scanning devices that are capable of scanning data from HD-DVDs, DVDs and CDs with three radiation beams of different wavelengths, whilst using the same objective lens. Furthermore, it is known in EP 01201255.5 to provide an NPS suitable for three wavelength simultaneously is discussed. The known NPS is a phase structure with a non-periodic stepped profile, arranged in the optical path of the three radiation beams, the structure including a plurality of steps with different heights for forming the non-periodic stepped profile.

Whilst the previously proposed scanning devices provide a solution for situations where three different optical media are illuminated with three associated different wavelengths of light using the same objective lens, they do not provide assistance in providing NPS structures easy to design and manufacture for fixed values of the wavelengths. As a result, the known NPS becomes complex, requiring the making of relatively high steps.

Accordingly, it is an object to an optical scanning device which has a single optical objective lens for scanning a variety of different optical record carriers using at least three radiation beams having three mutually different wavelengths.

This object is reached by an optical scanning device as described in the opening paragraph wherein, according to the invention, said phase structure includes birefringent material sensitive to said first, second and third polarizations and said stepped profile is designed for introducing a first wavefront modification, a second wavefront modification and a third wavefront modification for said first, second and third wavelengths, respectively, wherein at least one of said first, second and third wavefront modifications is of a type different from the others and at least one of said first, second and third polarizations differs from the others.

By forming the phase structure from the birefringent material sensitive to the different polarizations of the three radiation beams and by designing the stepped profile for introducing the first wavefront modification, the above-mentioned problem of compatibility in respect of the first wavelength is then solved. This will be explained in further detail below. Consequently, by comparison with the known NPS, there is for the NPS according to the invention an additional parameter (polarization) which can be used when designing, thereby giving rise to more design freedom. The phase introduced by a step height h made of a material having refractive index n at wavelength λ is given by

$$Φ = 2 π \frac{h ( n - 1 )}{λ} \qquad ( 1 )$$

Consequently, when the wavelength changes the phase introduced by a step changes. Furthermore, when changing the polarisation and thus changing the refractive index, also a change in phase introduced by the step is generated. Combining both effects for the three wavelengths system, designing NPS's generating predefined wavefronts for each wavelength is possible with relatively simple stepped structures.

Therefore, an advantage of the optical scanning device provided with the phase structure according to the invention is to scan optical carriers with a plurality of different radiation wavelengths, i.e. to provide a single device for scanning a number of different types of optical record carriers.

Another advantage of forming the phase structure according to the invention is to make a phase structure with less amplitude in the height of the steps than in the known phase structure as described in EP 01201255.5.

It is noted that such a phase structure has a non-periodic stepped profile, as opposed to diffraction parts which have each a periodic stepped profile. It is also noted that non-periodic structures and diffraction parts are different from each other in terms of structures and purposes. Thus, an NPS comprises a plurality of steps having differents heights so that the NPS has a non-periodic profile. The latter is designed for forming a wavefront modification from a radiation beam incident to the NPS. By contrast, a diffraction part includes a pattern of pattern elements having each one stepped profile. The latter is designed for forming, from a radiation beam incident to the part, a diffracted radiation beam (i.e. a plurality of radiation beams having each a diffraction order “m”, i.e. the zeroth order (m=0), the +1^{st}-order (m=1), etc., the −1^{th}-order (m=−1), etc.) with different transmission efficiencies for different diffraction orders.

In a first embodiment of the optical scanning device according to the invention, said stepped profile is designed for introducing: a second, flat wavefront modification for said second wavelength, and a third, flat wavefront modification for said third wavelength, where at least one of said first, second and third polarisations differs from the others.

In a second embodiment of the optical scanning device according to the invention, said stepped profile is designed for introducing: a second, flat wavefront modification for said second wavelength and, for said third wavelength, a third wavefront modification which substantially is of the same type as said first wavefront modification, where at least one of said first, second and third polarisations differs from the others.

According to another aspect of the invention, the extraordinary refractive index of said birefringent material substantially equals

$$1 + \frac{{λ}_{c}}{{λ}_{b}} ( {n}_{o} - 1 ) ,$$

where “nₒ” is the ordinary refractive index of said birefringent and “λ_{b}” and “λ_{c}” are two of said first, second and third wavelengths.

Another object of the invention to provide a phase structure suitable for use in an optical scanning device for scanning a first information layer by means of a first radiation beam having a first wavelength and a first polarization, a second information layer by means of a second radiation beam having a second wavelength and a second polarization, and a third information layer by means of a third radiation beam having a third wavelength and a third polarization, wherein said first, second and third wavelengths substantially differ from each other.

This object is reached by an optical scanning device as described in the opening paragraph wherein, according to the invention, said phase structure includes birefringent material sensitive to said first, second and third polarizations and said stepped profile is designed for introducing a first wavefront modification, a second wavefront modification and a third wavefront modification for said first, second and third wavelengths, respectively, wherein at least one of said first, second and third wavefront modifications is of a type different from the others and at least one of said first, second and third polarisation differs from the others.

In accordance with another aspect of the invention, there is provided a lens for use in an optical scanning device for scanning a first information layer by means of a first radiation beam having a first wavelength and a first polarization, a second information layer by means of a second radiation beam having a second wavelength and a second polarization, and a third information layer by means of a third radiation beam having a third wavelength and a third polarization, wherein said first, second and third wavelengths substantially differ from each other, the lens being provided with a phase structure according to the invention.

The objects, advantages and features of the invention will be apparent from the following, more detailed description of the invention, as illustrated in the accompanying drawings, in which:

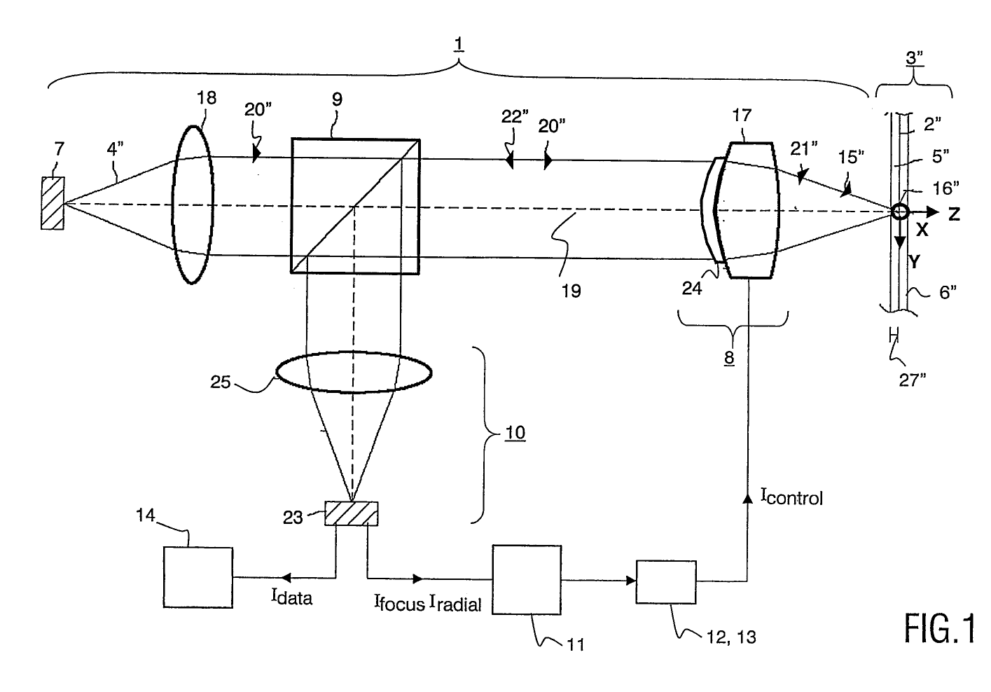

FIG. 1 is a schematic illustration of components of an optical scanning device 1 according to the invention,

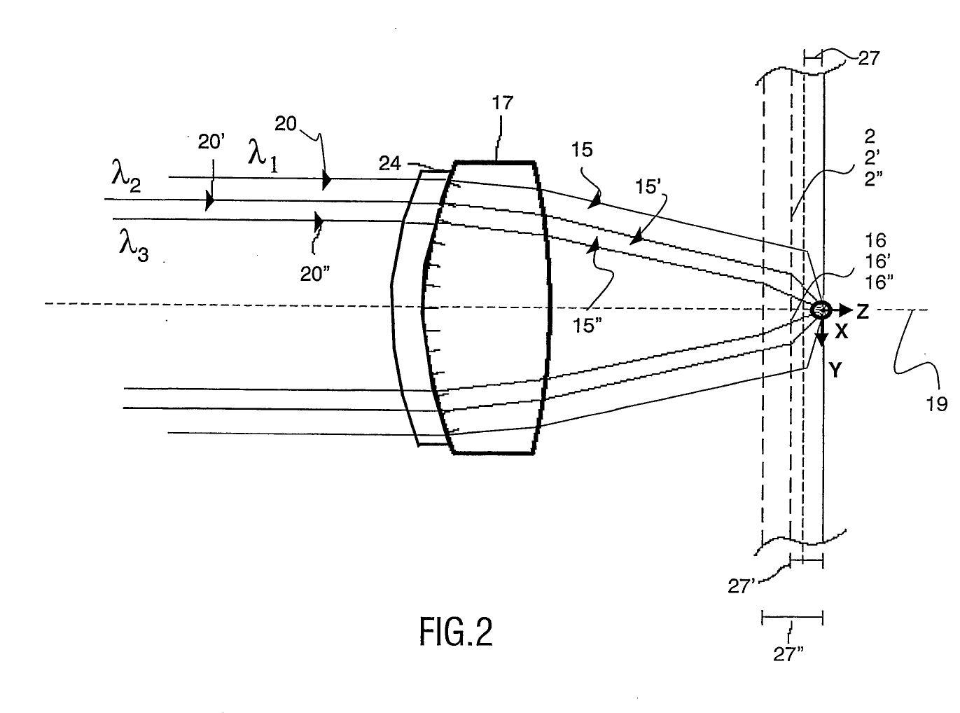

FIG. 2 is a schematic illustration of an objective lens for use in the scanning device of FIG. 1,

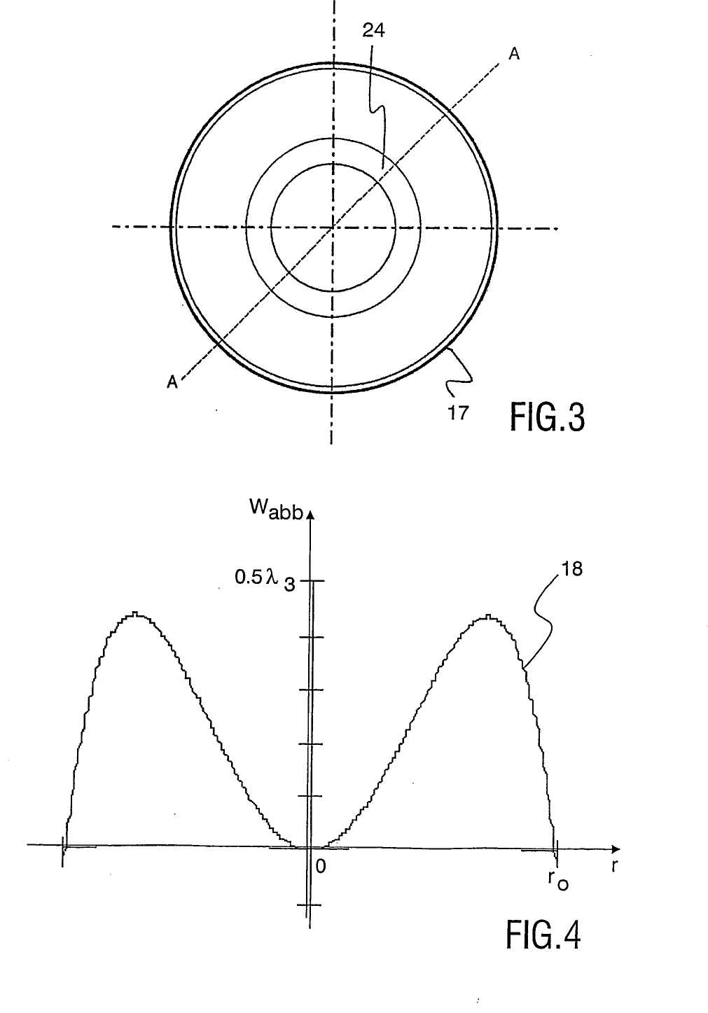

FIG. 3 is a schematic front view of the objective lens of FIG. 2,

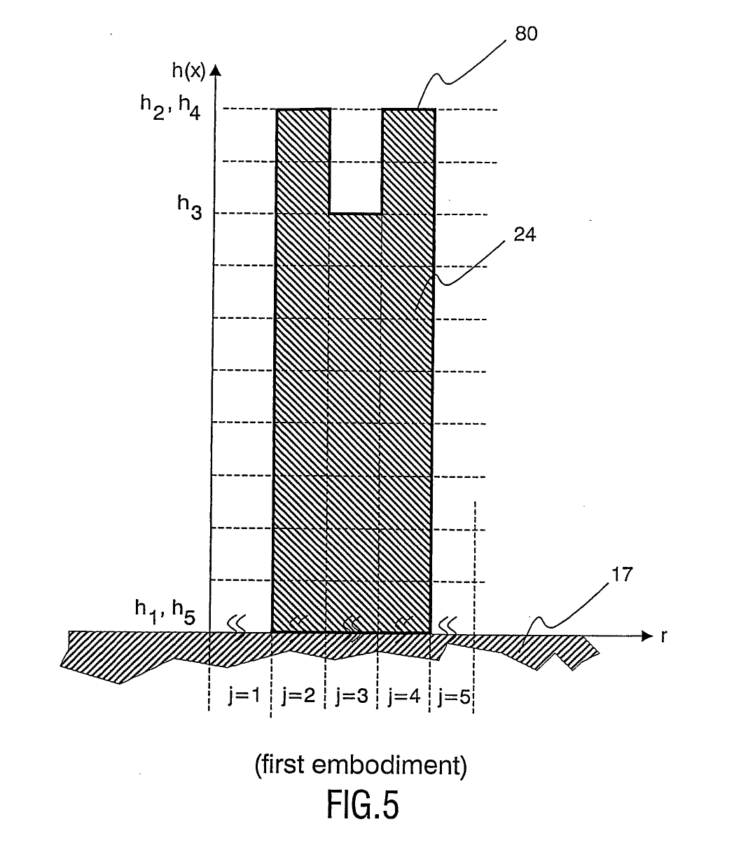

FIG. 4 shows a curve representing a wavefront aberration generated by the objective lens shown in FIGS. 2 and 3,

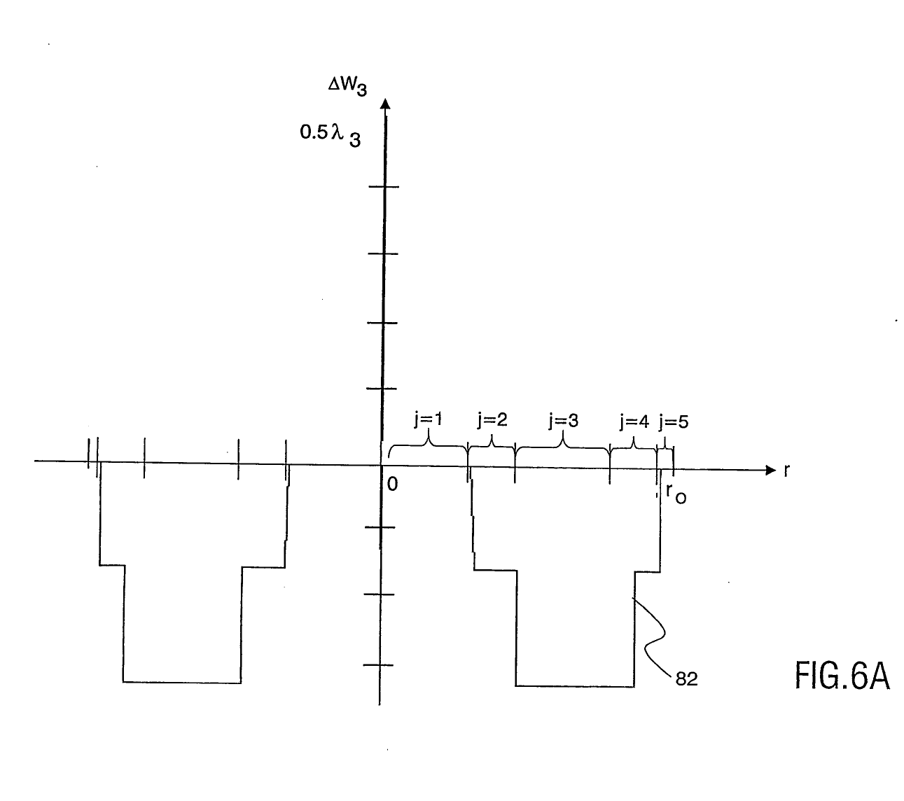

FIG. 5 shows a curve representing the step heights of a first embodiment of the NPS shown in FIGS. 2 and 3,

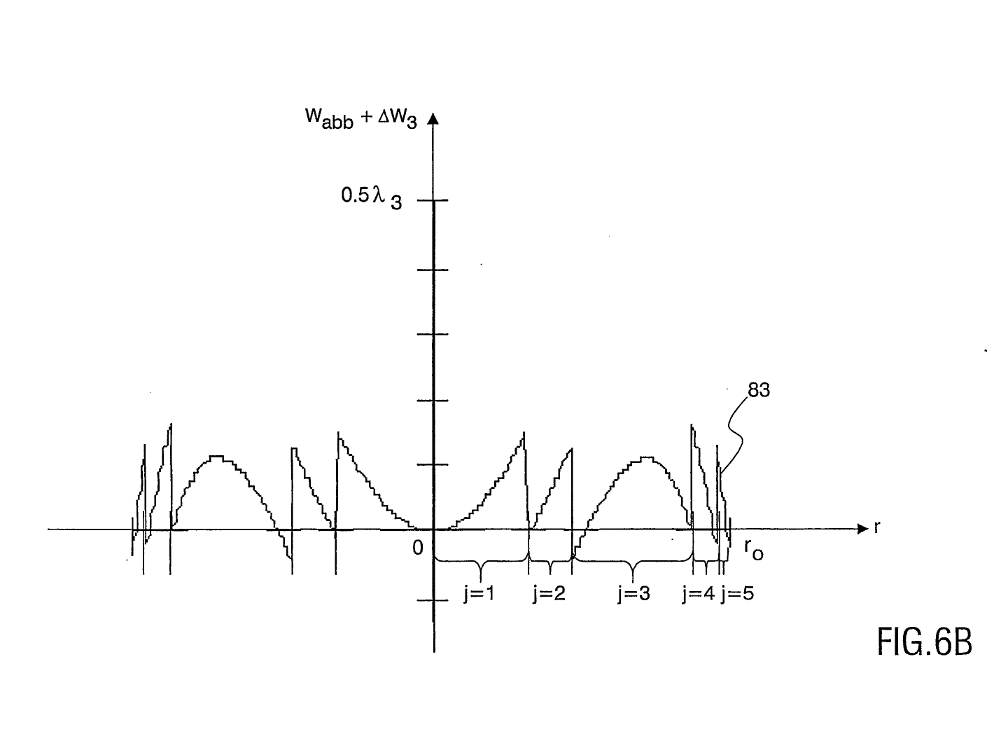

FIG. 6A shows a curve representing the wavefront modification introduced by the NPS shown in FIG. 5,

FIG. 6B shows a curve representing the combination of the wavefront aberration shown in FIG. 4 and the wavefront modification shown in FIG. 6A, and

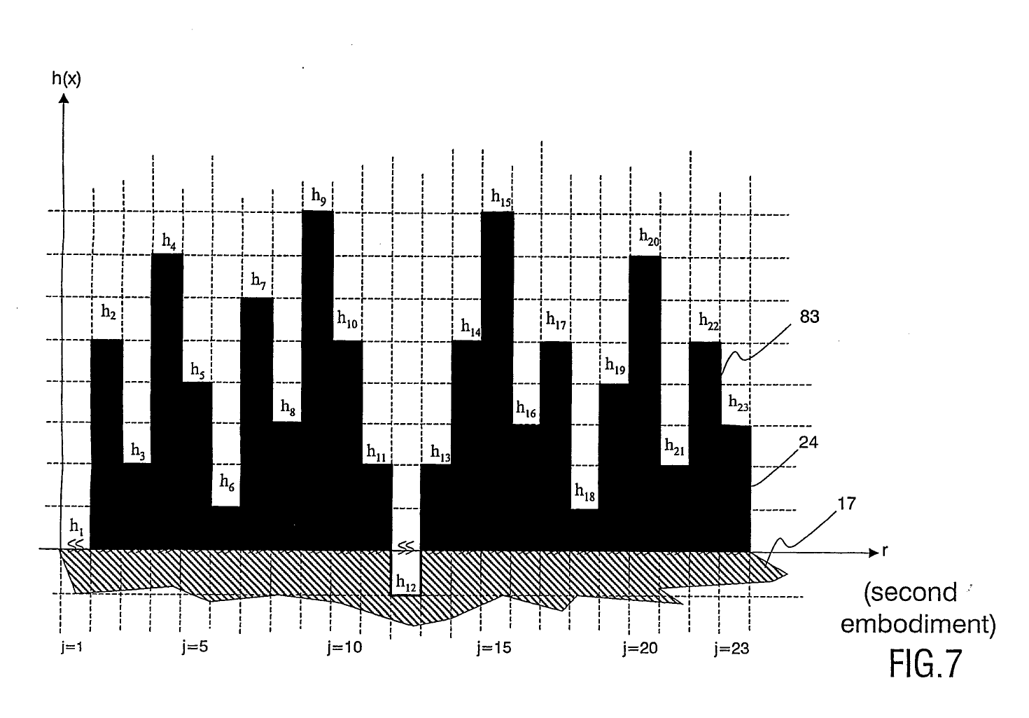

FIG. 7 shows a curve representing the step heights of a second embodiment of the NPS shown in FIGS. 2 and 3.

FIG. 1 is a schematic illustration of the optical components of an optical scanning device 1 according to one embodiment of the invention, for scanning a first information layer 2″ of a first optical record carrier 3″ by means of a first radiation beam 4″.

By way of illustration, the optical record carrier 3″ includes a transparent layer 5″ on one side of which the information layer 2″ is arranged. The side of the information layer facing away from the transparent layer 5″ is protected from environmental influences by a protective layer 6″. The transparent layer 5″ acts as a substrate for the optical record carrier 3″ by providing mechanical support for the information layer 2″. Alternatively, the transparent layer 5″ may have the sole function of protecting the information layer 2″, while the mechanical support is provided by a layer on the other side of the information layer 2″, for instance by the protective layer 6″ or by an additional information layer and transparent layer connected to the uppermost information layer. It is noted that the information layer has a first information layer depth 27″ that corresponds to, in this embodiment as shown in FIG. 1, to the thickness of the transparent layer 5″. The information layer 2″ is a surface of the carrier 3″. That surface contains at least one track, i.e. a path to be followed by the spot of a focused radiation on which path optically-readable marks are arranged to represent information. The marks may be, e.g., in the form of pits or areas with a reflection coefficient or a direction of magnetization different from the surroundings. In the case where the optical record carrier 3″ has the shape of a disc, the following is defined with respect to a given track: the “radial direction” is the direction of a reference axis, the X-axis, between the track and the center of the disc and the “tangential direction” is the direction of another axis, the Y-axis, that is tangential to the track and perpendicular to the X-axis.

As shown in FIG. 1, the optical scanning device 1 includes a radiation source 7, a collimator lens 18, a beam splitter 9, an objective lens system 8 having an optical axis 19, a phase structure or non-periodic structure (NPS) 24, and a detection system 10. Furthermore, the optical scanning device 1 includes a servocircuit 11, a focus actuator 12, a radial actuator 13, and an information processing unit 14 for error correction.

In the following “Z-axis” corresponds to the optical axis 19 of the objective lens system 8. It is noted that (X, Y, Z) is an orthogonal base.

The radiation source 7 is arranged for consecutively or simultaneously supplying the radiation beam 4″ and two other radiation beams 4 and 4′ (not shown in FIG. 1). For example, the radiation source 7 may comprise either a tunable semiconductor laser for consecutively supplying the radiation beams 4″, 4 and 4′ or three semiconductor lasers for simultaneously supplying these radiation beams. Furthermore, the radiation beam 4″ has a first wavelength λ₃ and a first polarization p₃, the radiation beam 4 has a second wavelength λ₁ and a second polarization p₁, and the radiation beam 4′ has a third wavelength λ₂ and a third polarization p₂. Examples of the wavelengths λ₁, λ₂ and λ₃ and the polarizations p₁, p₂ and p₃ will be given where the wavelengths λ₁, λ₂ and λ₃ substantially differ from each other and the polarization p₃ differs from at least one of the polarizations p₁ and p₂. It is noted in the present description that two wavelengths λₐ and λ_{b} are substantially different from each other where |λₐ−λ_{b}| is equal to or higher than, preferably, 10 nm and, more preferably, 20 nm, where the values 10 and 20 nm are a matter of a purely arbitrary choice.

The collimator lens 18 is arranged on the optical axis 19 for transforming the radiation beam 4″ into a first substantially collimated beam 20″. Similarly, it transforms the radiation beams 4 and 4′ into a second substantially collimated beam 20 and a third substantially collimated beam 20′ (not shown in FIG. 1).

The beam splitter 9 is arranged for transmitting the collimated radiation beams 20″, 20 and 20′ toward the objective lens system 8. Preferably, the beam splitter 9 is formed with a plane parallel plate that is tilted with an angle α with respect to the Z-axis and, more preferably, α=45°.

The objective lens system 8 is arranged for transforming the collimated radiation beam 20″ to a first focused radiation beam 15″ so as to form a first scanning spot 16″ in the position of the information layer 2″. Similarly, the objective lens system 8 transforms the collimated radiation beams 20 and 20′ as explained below.

In this embodiment, the objective lens system 8 includes an objective lens 17 provided with the NPS 24.

The NPS 24 includes birefringent material having an extraordinary refractive index nₑ and an ordinary refractive index nₒ. In the following the change in refractive index due to difference in wavelength is neglected and therefore the refractive indices nₑ and nₒ are approximately independent of the wavelength. In this embodiment, and by way of illustration only, the birefringent material is C6MWE7 50/50 (in % by weight) with nₒ=1.51 and nₑ=1.70. Alternatively, for example, the birefringent material may be C6M/C3M/E7 40/10/50 (in % by weight) with nₒ=1.55 and nₒ=1.69. The codes used refer to the following substances:
E7: 51% C5H11cyanobiphenyl, 25% C5H15cyanobiphenyl, 16% C8H17cyanobiphenyl, 8% C5H11cyanotriphenyl;
C3M: 4-(6-acryloyloxypropyloxy)benzoyloxy-2-methylphenyl 4-(6-acryloyloxypropyloxy)benzoate;
C6M: 4-(6-acryloyloxyhexyloxy)benzoyloxy-2-methylphenyl 4-(6-acryloyloxyhexyloxy) benzoate.

The NPS 24 is aligned such that the optic axis of the birefringent material is along the Z-axis. It is also aligned such that its refractive index equals nₑ when traversed by a radiation beam having a polarisation along the X-axis and nₒ when traversed by a radiation beam having a polarisation along the Y-axis. In the following the polarization of a radiation beam is called “pₑ” and “pₒ” where aligned with the X-axis and the Y-axis, respectively. Thus, where the polarization p₁, p₂ or p₃ equals pₑ, the refractive index of the birefringent material equals nₑ and, where the polarization p₁, p₂ or p₃ equals pₒ, the refractive index of the birefringent material equals nₒIn other words, the birefringent NPS 24 so aligned is sensitive to the polarizations p₁, p₂ and p₃. The NPS 24 will be described in further detail.

During scanning, the record carrier 3″ rotates on a spindle (not shown in FIG. 1) and the information layer 2″ is then scanned through the transparent layer 5″. The focused radiation beam 15″ reflects on the information layer 2″, thereby forming a reflected beam 21″ which returns on the optical path of the forward converging beam 15″. The objective lens system 8 transforms the reflected radiation beam 21″ to a reflected collimated radiation beam 22″. The beam splitter 9 separates the forward radiation beam 20″ from the reflected radiation beam 22″ by transmitting at least a part of the reflected radiation beam 22″ towards the detection system 10.

The detection system 6 includes a convergent lens 25 and a quadrant detector 23 which are arranged for capturing said part of the reflected radiation beam 22″ and converting it to one or more electrical signals. One of the signals is an information signal I_{data}, the value of which represents the information scanned on the information layer 2″. The information signal I_{data} is processed by the information processing unit 14 for error correction. Other signals from the detection system 10 are a focus error signal I_{focus} and a radial tracking error signal I_{radial}. The signal I_{focus} represents the axial difference in height along the Z-axis between the scanning spot 16″ and the position of the information layer 2″. Preferably, this signal is formed by the “astigmatic method” which is known from, inter alia, the book by G. Bouwhuis, J. Braat, A. Huijser et al, entitled “Principles of Optical Disc Systems,” pp. 75-80 (Adam Hilger 1985) (ISBN 0-85274-785-3). The radial tracking error signal I_{radial} represents the distance in the XY-plane of the information layer 2″ between the scanning spot 16″ and the center of a track in the information layer 2″ to be followed by the scanning spot 16″. Preferably, this signal is formed from the “radial push-pull method” which is known from, inter alia, the book by G. Bouwhuis, pp. 70-73.

The servocircuit 11 is arranged for, in response to the signals I_{focus} and I_{radial}, providing servo control signals I_{control} for controlling the focus actuator 12 and the radial actuator 13, respectively. The focus actuator 12 controls the position of the objective lens 17 along the Z-axis, thereby controlling the position of the scanning spot 16″ such that it coincides substantially with the plane of the information layer 2″. The radial actuator 13 controls the position of the objective lens 17 along the X-axis, thereby controlling the radial position of the scanning spot 16″ such that it coincides substantially with the center line of the track to be followed in the information layer 2″.

FIG. 2 is a schematic illustration of the objective lens 17 for use in the scanning device 1 described above.

The objective lens 17 is arranged for transforming the collimated radiation beam 20″ to the focused radiation beam 15″, having a first numerical aperture NA₃, so as to form the scanning spot 16″. In other words, the optical scanning device 1 is capable of scanning the first information layer 2″ by means of the radiation beam 15″ having the wavelength λ₃, the polarization p₃ and the numerical aperture NA₃.

Furthermore, the optical scanning device 1 is also capable of scanning a second information layer 2 of a second optical record carrier 3 by means of the radiation beam 4 and a third information layer 2′ of a third optical record carrier 3′ by means of the radiation beam 4′. Thus, the objective lens 17 transforms the collimated radiation beam 20 to a second focused radiation beam 15, having a second numerical aperture NA₁, so as to form a second scanning spot 16 in the position of the information layer 2. The objective lens 17 also transforms the collimated radiation beam 20′ to a third focused radiation beam 15′, having a third numerical aperture NA₂, so as to form a third scanning spot 16′ in the position of the information layer 2′.

Similarly to the optical record carrier 3″, the optical record carrier 3 includes a second transparent layer 5 on one side of which the information layer 2 is arranged with a second information layer depth 27, and the optical record carrier 3′ includes a third transparent layer 5′ on one side of which the information layer 2′ is arranged with a third information layer depth 27′.

It is noted that scanning information layers of the record carriers 3, 3′ and 3″ of different formats is achieved by forming the objective lens 17 as a hybrid lens, i.e. a lens combining an NPS and refractive elements, used in an infinite-conjugate mode. Such a hybrid lens can be formed by applying a stepped profile on the entrance surface of the lens 17, for example by a lithographic process using the photopolymerisation of, e.g., an UV curing lacquer, thereby advantageously resulting in the NPS 24 to be easy to make. Alternatively, such a hybrid lens can be made by diamond turning.

In the embodiment shown in FIGS. 1 and 2, the objective lens 17 is formed as a convex-convex lens; however, other lens element types such as plano-convex or convex-concave lenses can be used. In this embodiment, the NPS 24 is arranged on the side of a first objective lens 17 facing the radiation source 7 (referred to herein as the “entrance face”).

Alternatively, the NPS 24 is arranged on the other surface of the lens 17 (referred to herein as the “exit face”). Also alternatively, the objective lens 17 is, for example, a refractive objective lens element provided with a planar lens element forming the NPS 24. Also alternatively, the NPS 24 is provided on an optical element separate from the objective lens system 8, for example on a beam splitter or a quarter wavelength plate.

Also alternatively, whilst the objective lens 17 is in this embodiment a single lens, it may be a compound lens containing two or more lens element.

FIG. 3 is a schematic view of the entrance surface (also called “front view”) of the objective lens 17 shown in FIG. 2, illustrating the NPS 24.

The NPS 24 includes a plurality of steps “j” with different heights “hⱼ” for forming the non-periodic stepped profile. In the following “h” is the step height of the stepped profile, which is a function dependent on x. In the case of the stepped-profile approximation, the step height h is given by the following function:
h(x)=hⱼ for j−1≦x≦j (2a)
where “hⱼ” is the step height of the step j, which is a constant parameter. In the following “zone” is the length of a step along the X-axis.

The stepped profile is designed, i.e. the step height hⱼ are chosen, for introducing a first wavefront modification ΔW₃ (and therefore a first phase change Δφ₃) at the wavelength λ₃, a second wavefront modification ΔW₁ (and therefore a second phase change Δφ₁) at the wavelength λ₁, and a third wavefront modification ΔW₂ (and therefore a third phase change Δφ₂) at the wavelength λ₂. In other words, the stepped profile is designed so as to introduce the wavefront modifications ΔW₁, ΔW₂ and ΔW₃ in the radiation beams 15, 15′ and 15″ where these wavefront modifications are either flat of a type of a symmetric aberration.

In the following and by way of illustration only the wavefront modification ΔW₁ is flat. Thus, the step heights hⱼ are chosen so that the phase change Δφ₁ substantially equals a multiple of 2π, i.e. substantially equal zero modulo 2π. In this embodiment the wavelength λ₁ is said to be the design wavelength λ_{ref}. In other words,
λ_{ref}=λ₁ (2b)
Δφ₁≡0(2π). (2c)

This is achieved when each step height hⱼ is a multiple of a reference height h_{ref} which is dependent on the design wavelength λ_{ref} (i.e. the wavelength λ₁) as follows:

$${h}_{ref} = \frac{{λ}_{ref}}{n - {n}_{0}} \qquad ( 3 )$$

where “n” is the refractive index of the NPS 24 and nₒ is the refractive index of the adjacent medium that is, in the following and by way of illustration only, air, i.e. nₒ=1.

It is noted that the reference height h_{ref} is substantially constant, in the case where the NPS 24 is provided on a plane surface (e.g. on a plane parallel plate). Furthermore, in the case when the NPS 24 is provided on a curved surface (e.g. that of a lens), the NPS 24 may be adjusted over the length of the step so as to generate phase changes that are substantially equally to multiple of 2π.

Since the NPS 24 is made of birefringent material, its refractive index n equals nₑ when the polarization of the radiation beam traversing the NPS 24 equals pₑ and equals nₒ when the polarization of the radiation beam traversing the NPS 24 equals pₒ. Consequently, the reference height h_{ref} is dependent on the reference wavelength λ_{ref} and also the polarization p_{ref} of the reference wavelength λ_{ref} and in the following it is also referred to as “h_{ref}(λ_{ref},p_{ref})” Similarly, the phase changes Δφ₁, Δφ₂ and Δφ₃ are also dependent the respective polarizations p₁, p₂ and p₃ and in the following they are also referred to as “Δφ₁(p₁)”, “Δφ₂(p₂)” and “Δφ₃(p₃)”.

Consequently, it follows from Equations (2b) and (3) that:

$$\begin{matrix}{h}_{ref} ( {λ}_{ref} = {λ}_{1} , {p}_{ref} = {p}_{e} ) = \frac{{λ}_{1}}{{n}_{e} - {n}_{0}} & ( 4 a ) \\ {h}_{ref} ( {λ}_{ref} = {λ}_{1} , {p}_{ref} = {p}_{o} ) = \frac{{λ}_{1}}{{n}_{o} - {n}_{0}} & ( 4 b )\end{matrix}$$

Accordingly, in the case where, e.g., nₒ=1.50, nₑ=1.62 and λ₁=405 nm, the following is obtained from Equations (4a) and (4b):
h_{ref}(λ_{ref}=λ₁,p_{ref}=pₑ)=0.653 μm and
h_{ref}(λ_{ref}=λ₁,p_{ref}=pₒ)=0.810 μm.
It is also noted that, while a step height hⱼ introduces the value Δφ₁(p₁) (substantially equal to zero modulo 2π) for the radiation beam 15, it introduces the values Δφ₂(p₂) and Δφ₃(p₃) for the radiation beams 15′ and 15″, respectively, as follows:

$$\begin{matrix}Δ {Φ}_{2} ( {p}_{2} = {p}_{e} ) = 2 π \frac{{n}_{e} - {n}_{0}}{{λ}_{2}} {h}_{ref} ( {λ}_{ref} = {λ}_{1} , {p}_{ref} = {p}_{1} ) & ( 5 a ) \\ Δ {Φ}_{2} ( {p}_{2} = {p}_{o} ) = 2 π \frac{{n}_{o} - {n}_{0}}{{λ}_{2}} {h}_{ref} ( {λ}_{ref} = {λ}_{1} , {p}_{ref} = {p}_{1} ) & ( 5 b ) \\ Δ {Φ}_{3} ( {p}_{3} = {p}_{e} ) = 2 π \frac{{n}_{e} - {n}_{0}}{{λ}_{3}} {h}_{ref} ( {λ}_{ref} = {λ}_{1} , {p}_{ref} = {p}_{1} ) & ( 5 c ) \\ Δ {Φ}_{3} ( {p}_{3} = {p}_{o} ) = 2 π \frac{{n}_{o} - {n}_{0}}{{λ}_{3}} {h}_{ref} ( {λ}_{ref} = {λ}_{1} , {p}_{ref} = {p}_{1} ) & ( 5 d )\end{matrix}$$

Table I shows the values Δφ₂(p₂) and Δφ₃(p₃) where the radiation beams 15′ and 15″ traverse the step height hⱼ which equals either h_{ref}(λ_{ref}=λ₁,p_{ref}=pₑ) or h_{ref}(λ_{ref}=λ₁,p_{ref}=pₒ) in the cases where the polarizations p₂ and p₃ equal pₑ and/or pₒ. The values Δφ₂(p₂) and Δφ₃(p₃) have been calculated from Equations (4a), (4b) and (5a) to (5d) with, e.g., n₀=1.50, nₑ=1.62, λ₁=405 nm, λ₂=650 nm and λ₃=785 nm.

TABLE I

| | | ΔΦ₂(p₂)/2π | | ΔΦ₃(p₃)/2π | |
|---|---|---|---|---|---|
| | | (modulo 1) | | (modulo 1) | |
| | | p₂ = pₑ | p₂ = pₒ | p₃ = pₑ | p₃ = pₒ |
| hⱼ = h_{ref}(λ_{ref} = λ₁, | p₁ = pₑ | 0.623 | 0.502 | 0.516 | 0.416 |
| p_{ref} = p₁) | p₁ = pₒ | 0.773 | 0.623 | 0.640 | 0.516 |

It is further noted that a step height hⱼ equal to a multiple of h_{ref}(λ_{ref}=λ₁,p_{ref}=p₁) introduces the value Δφ₁(p₁) that equals zero modulo 2π for the radiation beam 15 and the values Δφ₂(p₂) and Δφ₃(p₃) that each equal one among a limited number of possible values. In the following “#Δφ₂” and “#Δφ₃” are such limited numbers for the values of the phase changes Δφ₂(p₂) and Δφ₃(p₃), respectively. Similarly to the phase changes Δφ₁, Δφ₂ and Δφ₃, the limited numbers #Δφ₂ and #Δφ₂ are also dependent the respective polarizations p₂ and p₃ and in the following they are also referred to as “#Δφ₂(p₂)” and “#Δφ₃(p₃)”, The limited numbers #Δφ₂(p₂) and #Δφ₃(p₃) have been calculated based on the theory of Continued Fractions, as known from, e.g., the European patent application filed on May 4, 2001 under the application number 01201255.5.

By way of illustration only, the calculation of the limited numbers #Δφ₃(p₃) is now described in a first case where the polarizations p₁ and p₃ are identical, e.g. p₁=pₒ and p₃=pₒ, and a second case where the polarization p₁ differs from the polarization p₃, e.g. p₁=pₒ and p₃=pₑ. With reference to said European patent application filed under the application number 01201255.5, the following is defined:

$$\begin{matrix}{a}_{0} = \frac{{H}_{1}}{{H}_{i}} & ( 6 a ) \\ {b}_{0} = Int [ {a}_{o} ] & ( 6 b ) \\ {a}_{1} = {a}_{0} - {b}_{0} & ( 6 c ) \\ {b}_{m} = Int [ \frac{1}{{a}_{m}} ] & ( 6 d ) \\ {a}_{m + 1} = \frac{1}{{a}_{m}} - {b}_{m} & ( 6 e ) \\ C {F}_{m} ≡ \{ {b}_{0} , {b}_{1} … {b}_{m} \} & ( 6 f )\end{matrix}$$

where H₁=h_{ref}(λ_{ref}=λ₁,p_{ref}=p₁), H₁=h_{ref}(λ_{ref}=λ₃,p_{ref}=p₃) and “m” is an integer equal to or higher than 1.

In the first case where p₁=pₒ and p₃=pₒ and where, e.g., nₒ=1.5, nₑ=1.62, λ₁=405 nm and λ₃=785 nm, the following is obtained from Equations (6a) to (6e):

$$\begin{matrix}{H}_{1} = {h}_{ref} ( {λ}_{ref} = {λ}_{1} , {p}_{ref} = {p}_{o} ) = \frac{{λ}_{1}}{{n}_{o} - {n}_{0}} = 0.810 µm \\ {H}_{i} = {h}_{ref} ( {λ}_{ref} = {λ}_{3} , {p}_{ref} = {p}_{o} ) = \frac{{λ}_{3}}{{n}_{o} - {n}_{0}} = 1.570 µm \\ {a}_{0} = 0.516 \\ {b}_{0} = 0 \\ {a}_{1} = 0.516 \\ {b}_{1} = 1 \\ {a}_{2} = 0.938 \\ {b}_{2} = 1 \\ C {F}_{2} = 0 + \frac{1}{1 + \frac{1}{1}} = \frac{1}{2}\end{matrix}$$

Thus, CF₂ substantially equals a₀, i.e. the following is met: |CF₂−a₀|=0.016<0.02 where 0.02 is a value chosen purely arbitrarily. As a result, it is found that the limited number #Δφ₃(p₃=pₒ) is equal to 2 where p₁=pₒ.

In the second case where p₁=pₒ and p₃=pₑ, and where, e.g., nₒ=1.50, nₑ=1.62, λ₁=405 nm and λ₃=785 nm, the following is obtained from Equations (6a) to (6e):

$${H}_{1} = {h}_{ref} ( {λ}_{ref} = {λ}_{1} , {p}_{ref} = {p}_{o} ) = \frac{{λ}_{1}}{{n}_{o} - {n}_{0}} = 0.810 µm$$

$${H}_{i} = {h}_{ref} ( {λ}_{ref} = {λ}_{3} , {p}_{ref} = {p}_{e} ) = \frac{{λ}_{3}}{{n}_{e} - {n}_{0}} = 1.266 µm$$

$${a}_{0} = 0.640 \\ {b}_{0} = 0 \\ {a}_{1} = 0.640 \\ {b}_{1} = 1 \\ {a}_{2} = 0.563 \\ {b}_{2} = 1 \\ {a}_{3} = 0.776 \\ {b}_{3} = 1 \\ {a}_{4} = 0.288 \\ {b}_{4} = 3 \\ {CF}_{4} = 0 + \frac{1}{1 + \frac{1}{1 + \frac{1}{1 + \frac{1}{3}}}} = \frac{7}{11}$$

Thus, CF₄ substantially equals a₀, i.e. the following is met: |CF₄−a₀|=0.004<0.02. As a result, it is found that the limited number #Δφ₃(p₃=pₑ) is equal to 11 where p₁=pₒ.

Table II shows the limited numbers #Δφ(λ=λ₂,p=p₂) and #Δφ(λ=λ₃,p=p₃) in respect of a step height hⱼ equal to h_{ref}(λ=λ₁,p=pₑ) and h_{ref}(λ=λ₁,p=pₒ) and in the cases where the polarizations p₂ and p₃ equal pₑ and/or pₒ. These limited numbers have been calculated on the theory of Continued Fractions as described above.

TABLE II

| | | #ΔΦ₂(p₂) | | #ΔΦ₃(p₃) | |
|---|---|---|---|---|---|
| | | p₂ = pₑ | p₂ = pₒ | p₃ = pₑ | p₃ = pₒ |
| hⱼ = h_{ref}(λ_{ref} = λ₁, | p₁ = pₑ | 8 | 2 | 2 | 5 |
| p_{ref} = p₁) | p₁ = pₒ | 9 | 8 | 11 | 2 |

It is noted in Tables I and II that if the polarizations p₁, p₂ and p₃ are identical, one of the limited numbers #Δφ₂(p₂) and #Δφ₃(p₃) equals 2, i.e. only two different values (zero and π modulo 2π) can be chosen for the corresponding phase changes. This does not allow a substantial degree of freedom for designing the NPS 24 in respect of the corresponding radiation beam.

By contrast, it is also noted in Tables I and II that if at least one of the polarizations p₁, p₂, p₃ differs from the others, at least three different values can be chosen for Δφ₂(p₂) and/or Δφ₃(p₃). The possibility for choosing the phase changes from at least three possible values allows to make an efficient NPS for each of the radiation beams 15, 15′ and 15″. Furthermore, this advantageously allows to design the stepped profile with a relatively low number of steps, typically less than 40 steps, since a stepped profile with a high number of steps (typically, 50 or more steps) is of less practical use.

Two embodiments of the stepped profile are now described where the wavefront modification ΔW₃ is of the type of a symmetric aberration and the wavefront modification ΔW₂ is flat in the first embodiment and of the type of a symmetric aberration in the second embodiment.

In the first embodiment and by way of illustration only the optical record carriers 3, 3′ and 3″ are a “HD-DVD”-format disc, a DVD-format disc and a CD-format disc, respectively. Firstly, the wavelength λ₁ is comprised in the range between 365 and 445 nm and, preferably, 405 nm. The wavelength λ₂ is comprised in the range between 620 and 700 nm and, preferably, 650 nm. The wavelength λ₃ is comprised in the range between 740 and 820 nm and, preferably, 785 nm. Secondly, the numerical aperture NA₁ equals about 0.6 in the reading mode and is above 0.6, preferably 0.65, in the writing mode. The numerical aperture NA₂ equals about 0.6 in the reading mode and is above 0.6, preferably 0.65, in the writing mode. The numerical aperture NA₃ is below 0.5, preferably 0.45. Thirdly, the polarizations p₁, p₂ and p₃ are as follows: p₁=pₑ, p₂=pₒ and p₃=pₒ.

In the first embodiment, the objective lens 17 is a plano-aspherical element (as shown in FIG. 2). The objective lens 17 has a thickness of 2.412 mm along on the Z-axis (i.e. the direction of its optical axis) and an entrance pupil with a diameter of 3.3 mm. The numerical aperture of the objective lens 17 is equal to 0.6 at the wavelength λ₁ (=405 nm), to 0.6 at the wavelength λ₂ (=650 nm), and to 0.45 at the wavelength λ₃ (=785 nm). The lens body of the objective lens is made of LAFN28 Schott glass with a refractive index that is equal to 1.7998 at the wavelength λ₁ (=405 nm), to 1.7688 at the wavelength λ₂ (=650 nm), and to 1.7625 at the wavelength λ₃ (=785 nm). The convex surface of the lens body which is directed towards the collimator lens 18 has a radius of 2.28 mm. The surface of the objective lens 17 facing the record carrier is flat. The aspherical shape is realized in a thin layer of acryl on top of the glass body. The lacquer has a refractive index equal to 1.5945 at the wavelength λ₁ (=405 nm), to 1.5646 at the wavelength λ₂ (=650 nm), and to 1.5588 at the wavelength λ₃ (=785 nm). The thickness of this layer on the optical axis is 17 μm. The rotational symmetric aspherical shape is defined by a function H(r) as follows:

$$H ( r ) = {\sum }_{i = 1}^{5} {B}_{2 i} {r}^{2 i} \qquad ( 7 )$$

where “H(r)” is the position of the surface along the optical axis of the lens 17 in millimeters, “r” is the distance to the optical axis in millimeters, and “Bₖ” are the coefficient of the k-th power of H(r). The value of the coefficients B₂ until B₁₀ are 0.238864, 0.0050434889, 7.3344175 10⁻⁵, −7.0483109 10⁻⁵, −4.7795094 10⁻⁶, respectively. The free working distance, i.e. the distance between the objective lens 17 and the optical record carrier, is equal: to 0.9676 nm at the wavelength λ₁ (=405 nm) for a DHD-DVD-format disk having a cover layer thickness of 0.6 mm, to 1.044 mm at the wavelength λ₂ (=650 nm) for a DVD-format disk having a cover layer thickness of 0.6 mm, and to 0.6917 mm at the wavelength λ₃ (=785 nm) for a CD-format disk having a cover layer thickness of 1.2 mm. The cover layer thickness of the disk is made of polycarbonate with refractive index equal to 1.6188 at the wavelength λᵢ (=405 nm), to 1.5806 at the wavelength λ₂ (=650 nm) and to 1.5731 at the wavelength λ₃ (=785 nm). The objective lens 17 is designed in such a way that, when scanning a HD-DVD-format disk at the wavelength λ₁ (=405 nm) and a DVD-format disc at the wavelength λ₂ (=650 nm), no spherochromatism is introduced. It is noted that the objective lens 17 is compatible with the “HD-DVD”-format and the DVD-format. In order to make the objective lens suitable for scanning a CD-format disk, the amount of spherical aberration W_{abb} arising due to the difference of cover layer thickness and spherochromatism has to be compensated. Spherical aberration can be expressed in the form of the Zernike polynomials. For further information, see e.g. M. Born and E. Wolf, “Principles of Optics,” p. 469-470 (6^{th} ed.) (Pergamon Press) (ISBN 0-08-09482-4). It is noted that, knowing the shape of the objective lens 17 from Equation (7), the amount of spherical aberration W_{abb} can be determined by ray-tracing simulations. FIG. 4 shows a curve 81 representing the wavefront aberration W_{abb} generated by the objective lens 17 according to Equation (7). It is noted in FIG. 4 that “rₒ” is the pupil radius of the face of the objective lens 17, which is provided with the NPS 24.

Therefore, in the first embodiment, the stepped profile is designed for compensating the wavefront aberration W_{abb} at the wavelength λ₃. Thus the step heights hⱼ are to be chosen such that the wavefront modifications ΔW₁ and ΔW₂ are substantially flat and such that the wavefront modification meets the following:
ΔW₃≈W_{abb} (8)
It is noted that the wavefront modifications ΔW₁ and ΔW₂ may substantially differ from each other by a substantially constant phase difference.

Accordingly, the step heights hⱼ are chosen such that both the phase changes Δφ₁(p₁) and Δφ₂(p₂) are substantially equal to a constant (e.g. zero) modulo 2π, where the phase changes Δφ₂(p₂) and Δφ₁(p₁) may substantially differ from each other, and such that the sum of the wavefront modification ΔW₃ and the wavefront aberration W_{abb} substantially equals zero. By way of illustration only, an example of the first embodiment of the stepped profile is described in the following where the stepped profile includes five steps.

Firstly, Table III shows the values ΔΦ₂(p₂) and ΔΦ₃(p₃) introduced by step heights that equal qh_{ref}(λ_{ref}=λ₁,p_{ref}=p₁) where p₁=pₑ and “q” is an integer. These values are found from Table I where the values ΔΦ₂(p₂) and ΔΦ₃(p₃) are known a step height that equals h_{ref}(λ_{ref}=λ₁,p_{ref}=p₁) where p₁=pₑ, i.e. for q=1.

TABLE III

| | ΔΦ₂(p₂)/2π (modulo 1) | ΔΦ₃(p₃)/2π (modulo 1) |
|---|---|---|
| q | p₂ = pₒ | p₃ = pₒ |
| 1 | 0.502 | 0.416 |
| 2 | 0.004 | 0.832 |
| 3 | 0.506 | 0.248 |
| 4 | 0.008 | 0.664 |
| 5 | 0.510 | 0.080 |
| 6 | 0.012 | 0.496 |
| 7 | 0.514 | 0.912 |
| 8 | 0.016 | 0.328 |
| 9 | 0.518 | 0.744 |
| 10 | 0.020 | 0.160 |
| 11 | 0.522 | 0.576 |
| 12 | 0.026 | 0.992 |

It is noted in Table III that the phase change ΔΦ₂(p₂) is substantially equal to zero or π modulo 2π and that the phase change ΔΦ₃(p₃) has substantially 5 substantially different values modulo 2π. This is consistent with Table II where #Δφ₂(p₂)=2 for p₂=pₒ and #Δφ₃(p₃)=5 for p₃=Pₒ.

It is also noted that, since the polarization p₃ differs from the polarization p₁, at least three different values of the phases changes ΔΦ₃(p₃) can be chosen, thereby resulting in allowing the design of the stepped profile with a relatively low number of steps, typically less than 40 steps, since a stepped profile with a high number of steps (typically, 50 or more steps) is of less practical use.

Secondly, Table IV shows the “optimized zones” of the step height hⱼ (=qh_{ref}=(λ_{ref}=λ₁,p_{ref}=p₁)) where p₁=pₑ and the values of the phase change ΔΦ₃(p₃)/2π, which are determined from Table III with p₃=pₒ and the wavefront aberration W_{abb} (see FIG. 4) according to the method known from said article by B. H. W. Hendriks et al. Table IV also shows, for the step height hⱼ, the values of the phase change ΔΦ₂(p₂) for approximating the flat wavefront modification ΔW₂ according to Table III where p₂=pₒ.

TABLE IV

| | Zones | | | ΔΦ₂(p₂) (mod. 2π) | ΔΦ₃(p₃) |
|---|---|---|---|---|---|
| | (mm) | q | hⱼ(μm) | p₂ = pₒ | (mod. 2π) p₃ = pₒ |
| j = 1 | 0.00-0.40 | 0 | 0.000 | 0.0000 | 0.000 |
| j = 2 | 0.40-0.59 | 10 | 6.530 | 0.1256 | 1.005 |
| j = 3 | 0.59-1.10 | 8 | 5.224 | 0.1005 | 2.061 |
| j = 4 | 1.10-1.20 | 10 | 6.530 | 0.1256 | 1.005 |
| j = 5 | 1.20-1.26 | 0 | 0.000 | 0.0000 | 0.000 |

It is also noted in Table IV that, due to the possibility to choose the value of the refractive index based on the polarizations of the radiation beams, the NPS has an advantageous stepped profile with a difference in the step heights of only 6.53 μm. By constrast, the NPS known from said patent application EP 01201255.5 has a difference in the step heights of more than 16 μm, thereby resulting in the known NPS which is difficult to make.

FIG. 5 shows a curve 80 representing the step height h(x) of the NPS 24 according to Table IV. It is noted in respect of the curve 80 that the stepped profile is designed such that the relative step heights hⱼ₊₁−hⱼ between adjacent steps include a relative step height having an optical path substantially equal to aλ₁, wherein “a” is an integer and a>1 and “λ₁” is the design wavelength. In other words, such a relative step height is higher than the reference height h_{ref}(λ=λ₁,p=p₁).

FIG. 6A shows a curve 82 representing the wavefront modification ΔW₃ introduced by the NPS shown in FIG. 5 for compensating the wavefront aberration W_{abb}. It is noted in FIG. 6A that the reference “j” corresponds to the steps as defined in relation with FIG. 5.

By comparison, FIG. 6B shows a curve 83 representing the combination of the wavefront aberration shown in FIG. 4 and the wavefront modification shown in FIG. 6A.

By referring again to Table IV, it is also noted that the phase changes ΔΦ₂(p₂) are substantially equal to zero, thereby introducing the flat wavefront modification ΔW₂, and that the phase change ΔΦ₃(p₃) associated with the corresponding optimized zones approximates the wavefront aberration W_{abb} (here, spherical aberration).

Table V shows the values OPDᵣₘₛ[W_{abb}+ΔWᵢ] for the wavefront modifications ΔW₁, ΔW₂ and ΔW₃ where the radiation beams 15, 15′ and 15″ (at the respective wavelengths and polarizations) traverse the NPS for compensating the wavefront aberration W_{abb} according to Table IV (and shown in FIG. 4). Table V also shows the values OPDᵣₘₛ[W_{abb}] associated with the wavefront aberration W_{abb} (i.e. without the correction of the NPS 24 according to Table IV). The values OPDᵣₘₛ[W_{abb}+ΔWᵢ] and OPDᵣₘₛ[W_{abb}] have been calculated from ray-tracing simulations.

TABLE V

| | OPDᵣₘₛ[W_{abb} + ΔWᵢ] | OPDᵣₘₛ[W_{abb}] |
|---|---|---|
| i = 1 (p₁ = pₑ) | 17.9 mλ | 17.9 mλ |
| i = 2 (p₂ = pₒ) | 8.6 mλ | 3.2 mλ |
| i = 3 (p₃ = pₒ) | 43.8 mλ | 134.1 mλ |

It is noted in Table V that the three values OPDᵣₘₛ[W_{abb}+ΔWᵢ] are below the diffraction limit, i.e. less than 70 mλ, for the NPS 24 according to Table IV, thereby allowing any format of optical record carriers to be scanned.

As an alternative of the first embodiment of the stepped profile, the values of the phase changes Δφ₂(p₂) and Δφ₁(p₁) are substantially equal to each other, where the polarization p₁ different from the polarization p₂, i.e.:
Δφ₂(p₂)=Δφ₁(p₁) (9)
In the case where p₁=pₒ, p₂=pₑ and p₃=Pₑ it derives from Equations (0c), (5b), (5c) and (9) that:

$$\frac{{λ}_{2}}{{n}_{e} - 1} = \frac{{λ}_{1}}{{n}_{o} - 1} \qquad ( 10 )$$

It follows from Equation (10) that:

$${n}_{e} = 1 + \frac{{λ}_{2}}{{λ}_{1}} ( {n}_{o} - 1 ) \qquad ( 11 )$$

Thus, for example, in the case where nₒ=1.5, λ₁=405 nm and λ₂=650 nm, it derives from Equation (11) that nₑ=1.802. Consequently, the birefringent material may be chosen where its refractive indices nₑ and nₒ substantially equal 1.802 and 1.5, respectively.

In the present description, two refractive indices nₐ and n_{b} are substantially equal where |nₐ−n_{b}| is equal to or less than, preferably, 0.01 and, more preferably, 0.005, where the values 0.01 and 0.005 are a matter of purely arbitrary choice.

In the second embodiment and by way of illustration only the optical record carriers 3, 3′ and 3″ are a BD-format disc, a DVD-format disc and a CD-format disc, respectively. Firstly, the wavelength λ₁ is comprised in the range between 365 and 445 nm and, preferably, 405 nm. The wavelength λ₁ is comprised in the range between 620 and 700 nm and, preferably, 650 nm. The wavelength λ₃ is comprised in the range between 740 and 820 nm and, preferably, 785 nm. Secondly, the numerical aperture NA₁ equals about 0.85 in the reading mode and in the writing mode. The numerical aperture NA₂ equals about 0.6 in the reading mode and is above 0.6, preferably 0.65, in the writing mode. The numerical aperture NA₃ is below 0.5, preferably 0.45. Thirdly, the polarizations p₁, p₂ and p₃ are as follows: p₁=pₑ, p₂=pₑ and p₃=pₒ.

In the second embodiment, the objective lens 17 is a bi-aspherical element. The objective lens. 17 has a thickness of 2.120 mm along the Z-axis (direction of its optical axis) and an entrance pupil with a diameter of 4.0 mm. The numerical aperture of the objective lens 17 is equal: to 0.85 at the wavelength λ₁ (=405 nm), to 0.6 at the wavelength λ₂ (=650 nm), and to 0.45 at the wavelength λ₃ (=785 nm). The lens body of the objective lens 17 is made of LASFN31 Schott glass with a refractive index equal to 1.9181 at the wavelength λ₃ (=405 nm), to 1.8748 at the wavelength λ₂ (650 nm), and to 1.8664 at the wavelength λ₃ (=785 nm). The rotational symmetric aspherical shape of the first and second surface of the objective lens 17 are given by the following equation:

$$H ( r ) = {\sum }_{i = 1}^{5} {B}_{2 i} {r}^{2 i} \qquad ( 12 )$$

where “H(r)” is the position of the surface along the optical axis of the lens 17 in millimeters, “r” is the distance to the optical axis in millimeters, and “Bₖ” is the coefficient of the k-th power of H(r). The value of the coefficients B₂ until B₁₄ for the first surface facing the laser are 0.27025467, 0.013621503, 0.0010887228, 0.00025122383, −5.8150037 10⁻⁵, 2.1911964 10⁻⁵, −1.965101 10⁻⁶, respectively. For the second surface facing the optical record carrier the value of the coefficients B₂ until B₁₄ for the first surface facing the laser are 0.085615362, 0.029034441, −0.031174254, 0.02322335, −0.012032137, 0.0035665564, −0.00044658898, respectively. The free working distance, i.e. the distance between the objective lens 17 and the optical record carrier, is equal: to 1.000 mm at the wavelength λ₁ (=405 nm) for a BD-format disk having a cover layer thickness of 0.1 mm, to 0.7961 mm at the wavelength λ₂ (=650 nm) for a DVD-format disk having a cover layer thickness of 0.6 mm, and to 0.4446 mm at the wavelength λ₃ (=785 nm) for a CD-format disk having a cover layer thickness of 1.2 mm. The cover layer thickness of the disk is made of polycarbonate with a refractive index equal: to 1.6188 at the wavelength λ₁ (=405 nm), to 1.5806 at the wavelength λ₂ (=650 nm), and to 1.5731 at the wavelength λ₃ (=785 nm). It is noted that the objective lens 17 is compatible with the BD-format. In order to make the objective lens suitable for scanning a DVD-format disc and a CD-format disk, spherical aberration arising due to the difference of cover layer thickness and spherochromatism has to be compensated. Spherical aberration can be expressed in the form of the Zernike polynomials. For further information, see e.g. M. Born and E. Wolf, “Principles of Optics,” p. 469-470 (6^{th} ed.) (Pergamon Press) (ISBN 0-08-09482-4). The amount of spherical aberration W_{abb} arising from the objective lens 17 as designed according to Equation (12) can be determined by ray-tracing as explained above with reference to FIG. 4.

Therefore, in the second embodiment, the stepped profile is further designed for compensating the wavefront aberration W_{abb} at the wavelengths λ₂ and λ₃. Thus the step heights hⱼ are to be chosen such that the wavefront modification ΔW₁ is flat and such that the wavefront modification ΔW₂ compensates a wavefront aberration W_{abb,2} for the wavelength λ₂ and the wavefront modification ΔW₃ compensates a wavefront aberration W_{abb,3} for the wavelength λ₃.

Accordingly, the step heights hⱼ are chosen such that both the phase change Δφ₁(p₁) is substantially equal zero modulo 2π and such that the sums of the wavefront modifications ΔW₂ and ΔW₃ and the wavefront aberration W_{abb} sucbtantially equal zero at the wavelengths at the wavelengths λ₂ and λ₃, respectively, where the phase changes Δφ₂(p₂) and Δφ₃(p₃) may substantially differ from each other. By way of illustration only, an example of the second embodiment of the stepped profile is described in the following where the stepped profile includes 23 steps.

Firstly, similarly to Table III, Table VI shows the values ΔΦ₂(p₂) and ΔΦ₃(p₃) introduced by step heights that equal qh_{ref}(λ_{ref}=λ₁,p_{ref}=p₁) where p₁=pₑ and “q” is an integer. These values are found from Table I where the values ΔΦ₂(p₂) and ΔΦ₃(p₃) are known a step height that equals h_{ref}(λ_{ref}=λ₁,p_{ref}=p₁) where p₁=pₒ, i.e. for q=1.

TABLE VI

| | ΔΦ₂(p₂)/2π | ΔΦ₃(p₃)/2π |
|---|---|---|
| q | p₂ = pₒ | p₃ = pₑ |
| −1 | 0.377 | 0.360 |
| 0 | 0.000 | 0.000 |
| 1 | 0.623 | 0.640 |
| 2 | 0.246 | 0.280 |
| 3 | 0.869 | 0.920 |
| 4 | 0.492 | 0.560 |
| 5 | 0.115 | 0.200 |
| 6 | 0.738 | 0.840 |
| 7 | 0.361 | 0.480 |
| 8 | 0.984 | 0.120 |
| 9 | 0.607 | 0.760 |

It is noted in Table VI that the phase changes ΔΦ₂(p₂) and ΔΦ₃(p₃) have 8 and 11 substantially different values modulo 2π, respectively. This is consistent with Table II where #Δφ₂(p₂)=8 for p₂=pₒ and #Δφ₃(p₃)=11 for p₃=pₑ.

It is also noted that, since the polarization p₃ differs from the polarizations p₁ and p₂, at least three different values of the phases changes ΔΦ₂(p₂) and ΔΦ₃(p₃) can be chosen, thereby resulting in allowing the design of the stepped profile with a relatively low number of steps, typically less than 40 steps, since a stepped profile with a high number of steps (typically, 50 or more steps) is of less practical use.

Secondly, similarly to Table IV, Table VII shows the “optimized zones” of the step height hⱼ (=qh_{ref}(λ_{ref}=λ₁,p_{ref}=p₁)) where p₁=pₑ and the values of the phase change ΔΦ₂(p₂)/2π and ΔΦ₃(p₃)/2π, which are determined from Table III with p₂=pₑ and p₃=pₒ and the wavefront aberration W_{abb} (see FIG. 4) according to the method known from said article by B. H. W. Hendriks et al.

Table VII also shows, for a step height qh_{ref}(λ_{ref}=λ₁,p_{ref}=p₁) where p₁=pₒ, the values of the phase change ΔΦ₂(p₂) for approximating the wavefront ΔW₂ of the type of spherical aberration according to Table VI where p₂=pₒ. Table VII also shows, for a step height qh_{ref})λ_{ref}=λ₁,p_{ref}=p₁), the values of the phase change ΔΦ₃(p₃) for approximating the optimized zones according to Table VI where p₃=pₑ. Table VII also shows the corresponding height hⱼ (calculated from Equation (4a) where p₁=pₒ).

TABLE VII

| | | | | ΔΦ₂(p₂) | ΔΦ₃(p₃) |
|---|---|---|---|---|---|
| | Zones [mm] | q | hⱼ(μm) | p₂ = pₒ | p₃ = pₑ |
| j = 1 | 0.000-0.230 | 0 | 0.000 | 0.000 | 0.000 |
| j = 2 | 0.230-0.320 | 5 | 4.050 | 0.723 | 1.257 |
| j = 3 | 0.320-0.400 | 2 | 1.620 | 1.546 | 1.759 |
| j = 4 | 0.400-0.470 | 7 | 5.670 | 2.268 | 3.016 |
| j = 5 | 0.470-0.530 | 4 | 3.240 | 3.091 | 3.519 |
| j = 6 | 0.530-0.580 | 1 | 0.810 | 3.914 | 4.021 |
| j = 7 | 0.580-0.640 | 6 | 4.860 | 4.637 | 5.278 |
| j = 8 | 0.640-0.690 | 3 | 2.430 | 5.460 | 5.781 |
| j = 9 | 0.690-0.750 | 8 | 6.480 | 6.183 | 7.037 |
| j = 10 | 0.750-0.820 | 5 | 4.050 | 7.006 | 7.540 |
| j = 11 | 0.820-0.900 | 2 | 1.620 | 7.829 | 8.042 |
| j = 12 | 0.900-1.150 | −1 | −0.810 | 8.652 | 8.545 |
| j = 13 | 1.150-1.205 | 2 | 1.620 | 7.829 | — |
| j = 14 | 1.205-1.240 | 5 | 4.050 | 7.006 | — |
| j = 15 | 1.240-1.270 | 8 | 6.480 | 6.183 | — |
| j = 16 | 1.270-1.295 | 3 | 2.430 | 5.460 | — |
| j = 17 | 1.295-1.315 | 6 | 4.860 | 4.637 | — |
| j = 18 | 1.315-1.335 | 1 | 0.810 | 3.914 | — |
| j = 19 | 1.335-1.352 | 4 | 3.240 | 3.091 | — |
| j = 20 | 1.352-1.368 | 7 | 5.670 | 2.268 | — |
| j = 21 | 1.368-1.380 | 2 | 1.620 | 1.546 | — |
| j = 22 | 1.380-1.395 | 5 | 4.050 | 0.723 | — |
| j = 23 | 1.395-1.325 | 3 | 0.000 | −0.823 | — |

It is noted in Table VII that both the phase changes ΔΦ₂(p₂) and ΔΦ₃(p₃) associated with the corresponding “optimized zones” approximate a wavefront modification of the type of spherical aberration and defocus. In other words, the optical scanning device provided with the NPS according to Table VII is advantageously compatible with the BD-format, the DVD-format and the CD-format, since it requires only one objective lens.

It is also noted that the polarization p₃ differs from the polarization p₁, at least three different values of the phases changes ΔΦ₂(p₂) and ΔΦ₃(p₃) can be chosen, thereby resulting in allowing the design of the stepped profile with a relatively low number of steps, typically less than 40 steps, since a stepped profile with a high number of steps (typically, 50 or more steps) is of less practical use.

FIG. 7 shows a curve 83 representing the step height h(x) of the NPS 24 according to Table VII. It is noted in respect of the curve 83 that the stepped profile is designed such that the relative step heights hⱼ₊₁−hⱼ between adjacent steps include a relative step height having an optical path substantially equal to aλ₁, wherein “a” is an integer and a>1 and “λ₁” is the design wavelength. In other words, such a relative step height is higher than the reference height h_{ref}(λ_{ref}=λ₁,p_{ref}=p₁).

Similarly to Table V, Table VIII shows the values OPDᵣₘₛ[W_{abb}+ΔWᵢ] for the wavefront modifications ΔW₁, ΔW₂ and ΔW₃ where the radiation beams 15, 15′ and 15″ (at the respective wavelengths and polarizations) traverse the NPS according to Table VII (and shown in FIG. 7). Table VIII also shows the values OPDᵣₘₛ[W_{abb}] associated with the wavefront aberration W_{abb} (i.e. without the correction of the NPS 24 according to Table VII). The values OPDᵣₘₛ[W_{abb}+ΔWᵢ] and OPDᵣₘₛ[W_{abb}] have been calculated from ray-tracing simulations.

TABLE VIII

| | OPDᵣₘₛ[W_{abb} + ΔWᵢ] | OPDᵣₘₛ[W_{abb}] |
|---|---|---|
| i = 1 (p₁ = pₒ) | 1.1 mλ | 1.1 mλ |
| i = 2 (p₂ = p) | 41.3 mλ | 466.8 mλ |
| i = 3 (p₃ = pₑ) | 64.4 mλ | 202.5 mλ |

It is noted in Table VIII that the three three values OPDᵣₘₛ[W_{abb}+ΔWᵢ] are below the diffraction limit, i.e. less than 70 mλ, for the NPS 24 according to Table VII, thereby allowing any format of optical record carriers to be scanned.

As an alternative of the second embodiment of the stepped profile, the value Δφ₂(p₂) is substantially equal to the value Δφ₃(p₃), where the polarization p₂ different from the polarization p₃, i.e.:
Δφ₂(p₂)=Δφ₃(p₃) (13)
In the case where p₁l=pₒ, p₂=pₒ and p₃=Pₑ it derives from Equations (0c), (5b), (5c) and (13) that:

$$\frac{{λ}_{2}}{{n}_{o} - 1} = \frac{{λ}_{3}}{{n}_{e} - 1} \qquad ( 14 )$$

It follows from Equation (14) that:

$${n}_{e} = 1 + \frac{{λ}_{3}}{{λ}_{2}} ( {n}_{o} - 1 ) \qquad ( 15 )$$

Thus, for example, in the case where nₒ=1.5, λ₃=785 nm and λ₂=650 nm, it derives from Equation (15) that nₑ=1.603. Consequently, the birefringent material may be chosen where its refractive indices nₑ and nₒ substantially equal 1.603 and 1.5, respectively.

Whilst in the above described embodiment an optical scanning device compatible with a CD-format disc, a DVD-format disc and a BD-format disc or HD-DVD format disc is described, it is to be appreciated that the scanning device according to the invention can be alternatively used for any other types of optical record carriers to be scanned.

An alternative of the stepped profile described above is designed for introduced a symmetric wavefront modification of a type other than spherical aberration, e.g., of the type of defocus. For more information on the mathematical functions representing such wavefront modifications, see, e.g. the book by M. Born and E. Wolf entitled “Principles of Optics,” pp. 464-470 (Pergamon Press 6^{th} Ed.) (ISBN 0-08-026482-4).

In other alternatives of the stepped profiles described above, the wavelength λ₂ or λ₃ is chosen as the design wavelength λ_{ref} Table IX shows the values of the reference height h_{ref}(λ,p) in the case where the wavelength λ_{ref} equals λ₂ or λ₃ and the polarization p_{ref} equals pₒ or pₑ and where, e.g., nₒ=1.5, nₑ=1.62, λ₂=650 nm and λ₃=785 nm.

TABLE IX

h_{ref}(λ_{ref}, p_{ref})

| | λ_{ref} = λ₂ | λ_{ref} = λ₃ |
|---|---|---|
| p_{ref} = pₒ | 1.300 μm | 1.570 μm |
| p_{ref} = pₑ | 1.048 μm | 1.266 μm |

An alternative to the NPS arranged on the entrance face of the objective lens may be of any shape like a plane.

As an alternative to the optical scanning device described with wavelengths of 785 nm, 660 nm and 405 nm are used, it is to be appreciated that radiation beams of any other combinations of wavelengths suitable for scanning optical record carriers may be used.

As another alternative to the optical scanning device described with the above values of numerical apertures, it is to be appreciated that radiation beams of any other combinations of numerical apertures suitable for scanning optical record carriers may be used.

As another alternative of the optical scanning device described above, at least one of the polarizations p₁, p₂ and p₃ is switched between a first state and a second state such that the NPS introduces a flat wavefront modification when that polarization is in the first state and a wavefront modification of a type of spherical aberration or defocus when that polarization is in the second state. It is noted that the switching of each of the polarizations p₁, p₂ and p₃ is known, e.g., from the European Patent application filed on Jul. 12, 2001 with the application number EP 01204786.6.

Alternatively, at least one of the polarizations p₁, p₂ and p₃ is switched between a first state and a second state such that the NPS introduces a first amount of wavefront modification of the type(s) of spherical aberration and/or defocus when that polarization is in the first state and a second, different amount of wavefront modification of the type(s) of spherical aberration and/or defocus when that polarization is in the second state.

In a particular case, each of the polarizations p₁, p₂ and p₃ is switched between a first state and a second state such that the NPS introduces a flat wavefront modification when the polarizations p₁, p₂ and p₃ are in the first states and a wavefront modification of the type(s) of spherical aberration and/or defocus when the polarizations p₁, p₂ and p₃ are in the second states. This advantageously allows to design the NPS for introducing, in respect of the wavelengths λ₁, λ₂ and λ₃: three respective flat wavefront modifications when the polarizations p₁, p₂ and p₃ are in the first states, respectively, and three wavefront modifications of the type(s) of spherical aberration and/or defocus when the polarizations p₁, p₂ and p₃ are in the second states, respectively. Accordingly, the NPS has no optical effect where the polarizations p₁, p₂ and p₃ are in the first states and has an optical effect (by generating wavefront modifications of the type(s) of spherical aberration and/or defocus) where the polarizations p₁, p₂ and p₃ is in the second states.

It is noted in respect of the above that the polarizations p₁, p₂ and p₃ can be switched independently so that the optical scanning device provide with such a NPS has eight different configurations.

1. An optical scanning device (1) for scanning a first information layer (2″) by means of a first radiation beam (4″) having a first wavelength (λ₃) and a first polarization (p₃), a second information layer (2) by means of a second radiation beam (4) having a second wavelength (λ₁) and a second polarization (p₁), and a third information layer (2′) by means of a third radiation beam (4′) having a third wavelength (λ₂) and a third polarization (p₂), wherein said first, second and third wavelengths substantially differ from each other, the device comprising:
a radiation source (7) for emitting said first, second and third radiation beams consecutively or simultaneously,
an objective lens system (8) for converging said first, second and third radiation beams beam on the positions of said first, second and third information layers, and
a phase structure (24) with a non-periodic stepped profile, arranged in the optical path of said first, second and third radiation beams, the structure including a plurality of steps (j) with different heights (hⱼ) for forming said non-periodic stepped profile, characterised in that:
said phase structure (24) includes birefringent material sensitive to said first, second and third polarizations (p₃, p₁, p₂) and
said stepped profile is designed for introducing a first wavefront modification (ΔW₃), a second wavefront modification (ΔW₁) and a third wavefront modification (ΔW₂) for said first, second and third wavelengths (λ₃, λ₁, λ₂), respectively, wherein at least one of said first, second and third wavefront modifications is of a type different from the others and at least one of said first, second and third polarizations (p₃, p₁, p₂) differs from the others.

2. An optical scanning device (1) according to claim 1, wherein said first wavefront modification (ΔW₃) is substantially of the type(s) of spherical aberration and/or defocus.

3. An optical scanning device (1) according to claim 1, wherein said second wavefront modification (ΔW₁) is substantially flat.

4. An optical scanning device (1) according to claim 3, wherein said third wavefront modification (ΔW₂) is substantially flat.

5. An optical scanning device (1) according to claim 4, wherein said stepped profile is further designed for introducing substantially identical phase changes (ΔΦ₁, ΔΦ₂) for both said second and third wavelengths (λ₁, λ₂), and wherein said third polarisation (p₂) differs from said second polarisation (p₁).

6. An optical scanning device (1) according to claim 5, wherein the extraordinary refractive index (nₑ) of said birefringent material substantially equals
$$1 + \frac{{λ}_{c}}{{λ}_{b}} ( {n}_{o} - 1 ) ,$$
where “nₒ” is the ordinary refractive index of said birefringent and “λ_{b}” and “λ_{c}” are either said second and third wavelengths (λ₁, λ₂), respectively, or said third and second wavelengths (λ₂, λ₁), respectively.

7. An optical scanning device (1) according to claim 3, wherein said third wavefront modification (ΔW₂) is substantially of the same type as said first wavefront modification (ΔW₃).

8. An optical scanning device (1) according to claim 7, wherein said stepped profile is further designed for introducing substantially identical phase changes (ΔΦ₂, ΔΦ₃) for both said first and third wavelengths (λ₃, λ₂), and wherein said third polarisation (p₂) differs from said first polarisation (p₃).

9. An optical scanning device (1) according to claim 8, wherein the extraordinary refractive index (nₑ) of said birefringent material substantially equals
$$1 + \frac{{λ}_{c}}{{λ}_{b}} ( {n}_{o} - 1 ) ,$$
where “nₑ” is the ordinary refractive index of said birefringent and “λ_{b}” and “λ_{c}” are either said first and third wavelengths (λ₃, λ₂), respectively, or said third and first wavelengths (λ₂, λ₃), respectively.

10. An optical scanning device (1) according to claim 1, wherein said heights (hⱼ) are further designed such that the relative step heights (hⱼ₊₁−hⱼ) between adjacent steps (j, j+1) include a relative step height having an optical path substantially equal to aλ₁, wherein “a” is an integer and a>1 and “λ₁” is said second wavelength.

11. An optical scanning device (1) according to claim 1, wherein said phase structure (24) is generally circular and said steps (j) are generally annular.

12. An optical scanning device (1) according to claim 1, wherein said phase structure (24) is formed on a face of a lens of said objective lens system (8).

13. An optical scanning device (1) according to claim 1, wherein said phase structure (24) is formed on an optical plate provided between said radiation source (7) and said objective lens system (8).

14. An optical scanning device according to claim 13, wherein said optical plate comprises a quarter wavelength plate or a beam splitter.

15. A phase structure (24) for use in an optical scanning device (1) for scanning a first information layer (2″) by means of a first radiation beam (4″) having a first wavelength (λ₃) and a first polarization (p₃), a second information layer (2) by means of a second radiation beam (4) having a second wavelength (λ₁) and a second polarization (p₁), and a third information layer (2′) by means of a third radiation beam (4′) having a third wavelength (λ₂) and a third polarization (p₂), wherein said first, second and third wavelengths substantially differ from each other, the structure being arranged in the optical path of said first, second and third radiation beams and having a non-periodic stepped profile, characterised in that:
said phase structure (24) includes birefringent material sensitive to said first, second and third polarizations (p₃, p₁, p₂) and
said stepped profile is designed for introducing a first wavefront modification (ΔW₃), a second wavefront modification (ΔW₁) and a third wavefront modification (ΔW₂) for said first, second and third wavelengths (λ₃λ₁, λ₂), respectively, wherein at least one of said first, second and third wavefront modifications is of a type different from the others and at least one of said first, second and third polarizations (p₃, p₁, p₂) differs from the others.

16. A lens (17) for use in an optical scanning device (1) for scanning a first information layer (2″) by means of a first radiation beam (4″) having a first wavelength (λ₃) and a first polarization (p₃), a second information layer (2) by means of a second radiation beam (4) having a second wavelength (λ₁) and a second polarization (p₁), and a third information layer (2′) by means of a third radiation beam (4′) having a third wavelength (λ₂) and a third polarization (p₂), wherein said first, second and third wavelengths substantially differ from each other, the lens being provided with a phase structure according to claim 15.
